(19) United States
(12) Patent Application Publication
(10) Pub. No.: US 2023/0325632 A1
(43) Pub. Date: Oct. 12, 2023

(54) AUTOMATED ANOMALY DETECTION USING A HYBRID MACHINE LEARNING SYSTEM

(71) Applicant: WORKDAY, INC., Pleasanton, CA (US)

(72) Inventors: Rivaz KASMANI, Fremont, CA (US); Daniel ALVAREZ, East Elmhurst, NY (US); Monika PANDEY, Pune (IN)

(21) Appl. No.: 17/705,940

(22) Filed: Mar. 28, 2022

(51) Int. Cl. G06N 3/04; G06N 3/08

(52) U.S. Cl. CPC G06N 3/0454; G06N 3/088

(57) ABSTRACT

In some aspects, the techniques described herein relate to a method including receiving, by a processor, raw data representing interactions; generating, by the processor, a feature set based on the raw data, a given feature in the feature set including at least a portion of the raw data and at least one engineered feature; generating, by the processor, a first score for the feature set using a machine learning (ML) model, the first score representing an anomaly score; generating, by the processor, one or more second scores, each score in the one or more second scores generated by performing a linear operation on one or more features in the feature set; aggregating, by the processor, the first score and the one or more second scores to generate a total score; and outputting, by the processor, the total score.

### BACKGROUND

Many data-driven systems rely on auditors to verify the integrity of stored data (e.g., verify compliance with company policies, identify process gaps, and identify malicious behavior). Many systems rely on sampling large datasets to perform this function: selecting a representative subset of all records and manually performing auditing on the subset.

Such an approach inherently fails to capture nuances in datasets that are not amenable to sample-based analysis. For example, process gaps and unknown scenarios are generally not amenable to such analysis. Further, risks identified using sampling are not equivalent. Thus, human auditors may only focus on larger risk data records while ignoring lower risk data records that, in aggregate, can be significant.

In such systems, scaling is infeasible. That is, scaling such systems requires further human review and analysis, which is often impossible given the processing time requirements of large datasets.

### BRIEF DESCRIPTION OF THE FIGURES

FIG. 1 is a block diagram illustrating a system for generating risk scores for data records according to some of the example embodiments.

FIG. 2 is a block diagram of a risk scorer according to some of the example embodiments.

FIG. 3 is a flow diagram illustrating a method for assigning a risk score to a data record according to some of the example embodiments.

FIG. 4 is a flow diagram illustrating a method for generating a feature set based on a raw data record according to some of the example embodiments.

FIG. 5 is a flow diagram illustrating a method for applying one or more rule-based filters to a feature set according to some of the example embodiments.

FIG. 6 is a block diagram of a computing device according to some embodiments of the disclosure.

### DETAILED DESCRIPTION

The example embodiments remedy the aforementioned problems by utilizing a hybrid machine learning (ML) approach for assigning risk scores to data records.

In the various embodiments, a risk engine is described that includes a risk scorer that reads data records from a raw data source and generates risk scores for each corresponding data record. In some embodiments, the risk scorer can include a feature generator for converting raw data records into feature sets. The feature generator can use deterministic logic to synthesize new features from the raw data. For example, the feature generator can generate numerical features from categorical raw data variables. The feature generator can also use ML models to generate predictive features based on the raw features. For example, the feature generator can probabilistically predict if the raw category assigned to the data record is incorrect.

The feature generator can output a data record’s feature set to an ML model (or multiple ML models) and one or more rule-based filters. In an embodiment, the ML model can predict a score based on the feature set. In various embodiments, the ML model can comprise an autoencoder network, isolation forest, or histogram-based outlier model (although other models may be contemplated). The rule-based filters can comprise linear operations performed on some or all the features in the feature set. In some embodiments, the linear operations can comprise weighting operations performed on numeric representations of the features in the feature set. In some embodiments, there may be multiple rule-based filters, and the resulting outputs can be aggregated into a single rule-based score (via, for example, an interim aggregation node). In some embodiments, certain rule-based filters can be isolated from others, and their output scores can be used directly. A total aggregation node can then receive all of the scores (e.g., the ML model score, the aggregated rule-based score, and any isolated rule-based scores) and generate a total score for a given data record. In some embodiments, the total aggregation node can compute the sum of all the scores and use the resulting sum as the risk score for the data record represented by the feature set.

In contrast to existing approaches, the example embodiments can operate on all (or most) data records in a dataset and provide risk scores for every transaction based on a combination of a trained ML model and flexible entity-specific rules. Further, unlike pure ML approaches to anomaly detection, the example embodiments can be tuned based on the overall risk of an anomaly to an organization. Thus, the example embodiments combine both highly adaptable ML scoring with entity-specific rules that can refine the predictions of the ML model.

In some embodiments, a method is disclosed that includes a processor receiving raw data representing interactions and generating a feature set based on the raw data. In these embodiments, a given feature in the feature set includes at least a portion of the raw data and an engineered feature. The method can then include generating a first score for the feature set using an ML model, the first score representing an anomaly score. The method then can include generating second scores, each of the second scores generated by performing a linear operation on one or more features in the feature set. The method then can include aggregating the first score and the one or more second scores to generate a total score which is then output.

In some embodiments, generating the first score for the feature set using the ML model includes inputting the feature set into an ensemble ML model. For example, in some embodiments, the ensemble ML model can include an autoencoder network, isolation forest, or histogram-based outlier score model. In some embodiments, the method can further include generating the engineered feature using a second ML model configured to predict a misclassification of the raw data. In some embodiments, the method can further include generating a third score that is based on comparing a numerical feature in the raw data to a fixed scale of numerical values.

In some embodiments, the foregoing method embodiments may also be performed by a computing device or system, or may be embodied in a non-transitory computer-readable storage medium tangibly storing computer program instructions implementing the method.

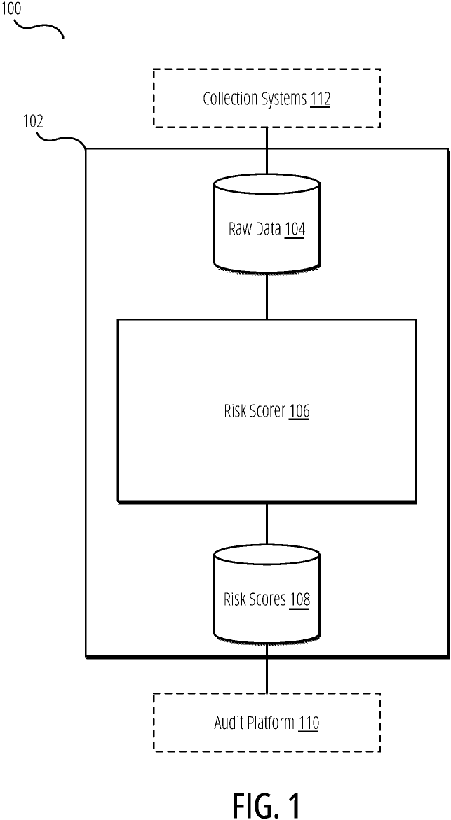

FIG. 1 is a block diagram illustrating a system for generating risk scores for data records according to some of the example embodiments.

In an embodiment, a system 100 includes a risk engine 102 that receives data from collection systems 112 and stores the data in raw data store 104. Periodically, a risk scorer 106 in risk engine 102 can read raw data records from raw data store 104 and output risk scores for each raw data record to a risk score store 108. Subsequently, downstream applications, such as audit platform 110, can use the risk scores stored in risk score store 108 for further operations.

In some embodiments, the risk engine 102 can be included in an existing computing system. For example, collection systems 112 can comprise any type of computing system or network that can collect data from users or other computing systems. As one example, the collection systems 112 can comprise an expense reporting system that allows users or computing devices to enter details of expense data records for an organization. Such expense data records can include, for example, line-item details, a report number, a category for the expense, an amount value, etc. While expenses records are periodically used as examples, the disclosure is not limited as such, and any type of data records that can include anomalous data points may also be used as input data for risk engine 102.

In some embodiments, the collection systems 112 can periodically write data to the raw data store 104. In some embodiments, the raw data store 104 can comprise any type of persistent data storage device. For example, the raw data store 104 can comprise a relational database, NoSQL database, flat file, key-value database, big data storage device, etc. In some embodiments, the raw data store 104 can comprise a canonical data source and thus may only be one-time writable by collection systems 112. In some embodiments, the risk scorer 106 may not be allowed to modify data stored in raw data store 104. Thus, the raw data store 104 may be read-only for risk scorer 106.

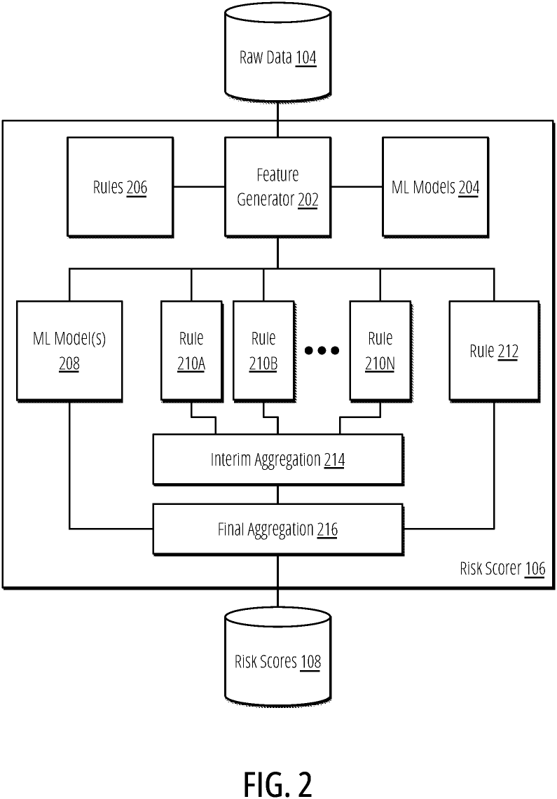

In an embodiment, the risk scorer 106 is configured to periodically read raw data records from raw data store 104 and generate corresponding risk scores for each data record stored in raw data store 104. Specifically, structural and functional details of risk scorer 106 are described in more detail in the following FIGS. 2 through 5 and are not repeated herein but are incorporated in their entirety. In an embodiment, the risk scorer 106 ultimately outputs the generated risk scores to risk score store 108. In an embodiment, the risk score store 108 can comprise any type of persistent data storage device. For example, the risk score store 108 can comprise a relational database, NoSQL database, flat file, key-value database, big data storage device, etc. In some embodiments, the risk score store 108 can store only the risk scores and a reference (e.g., foreign key) to the corresponding raw data record stored in raw data store 104. In other embodiments, the risk scorer 106 can write the feature set used to generate a risk score along with the risk score to risk score store 108. In some embodiments, the risk scorer 106 can write the raw data, the feature set, and the risk score to risk score store 108.

As illustrated, downstream applications may access risk scores in risk score store 108 and provide further functionality built on top of the risk scores. For example, audit platform 110 can read risk scores for a set of raw data records and present the original raw data and risk scores to a human auditor (e.g., via a web interface) for manual review. In some embodiments, since the risk scores may be stored in a structured storage device, the audit platform 110 can sort or otherwise order, group, filter, or organize the risk scores based on the needs of the audit platform 110. For example, the audit platform 110 can define a fixed risk score threshold and only provide those raw data records having risk scores exceeding the threshold to the user. As another example, the audit platform 110 can sort the raw data records based on the risk scores (e.g., highest score to lowest) and present the ordered raw data records to a human reviewer, ensuring the human reviewer can view the riskiest raw data records first. While the foregoing description focuses on auditing operations, other downstream operations that can utilize risk scores may also be implemented.

FIG. 2 is a block diagram of a risk scorer according to some of the example embodiments.

In an embodiment, a risk scorer 106 includes a feature generator 202, feature ML models 204, feature generation rules 206, scoring ML models 208, rule-based filters (e.g., rule-based filter 210A, rule-based filter 210B, and rule-based filter 210N), isolated rule-based filters (e.g., isolated rule-based filter 212), an interim aggregation node 214, and a total aggregation node 216. In some embodiments, the risk scorer 106 can be implemented as a collection of software modules executing on a computing device. In other embodiments, the various components of risk scorer 106 can be implemented as software, or hardware, implemented separately from other components (e.g., in a cloud-based deployment).

In an embodiment, the feature generator 202 can read a raw data record from raw data store 104. Certainly, in operation, the feature generator 202 can read multiple raw data records from raw data store 104. However, for ease of description, retrieving only a single raw data record is described. Details of raw data records were provided previously and are not repeated herein.

In an embodiment, the feature generator 202 converts a raw data record into a feature set that includes a plurality of individual features. In some embodiments, the features can include a mix of categorical and numerical features. In other embodiments, the features may include only categorical features. As illustrated, the feature generator 202 outputs the feature set to ML models 208, rule-based filters (e.g., rule-based filter 210A, rule-based filter 210B, and rule-based filter 210N), and isolated rule-based filter 212 for processing.

In an embodiment, some of the features generated by feature generator 202 can comprise raw features. In an embodiment, raw features comprise data in raw data records that is included, unchanged, in the feature set. For example, a dollar amount of an expense or a date may be included as a raw feature. In some embodiments, the feature generator 202 can be configured to select a subset of the raw features for including in the feature set (or for further processing, discussed next). For example, an operator of the system can select a small subset of raw features to seed the feature generator 202.

In an embodiment, the feature generator 202 can provide some or all the raw features to feature generation rules 206 and to feature ML models 204 to generate rule-based features and predictive features, respectively. Both feature ML models 204 and feature generation rules 206 process the raw data to generate synthesized features, as will be discussed.

In an embodiment, the feature generation rules 206 can apply procedural operations to raw features to obtain synthesized features. In an embodiment, these procedural operations may be stateless. That is, the rules can be applied in a repeatable manner to a given set of raw features.

As one example, the feature generation rules 206 can analyze a raw date feature and output a Boolean feature that indicates whether the raw date is a certain day of the week. As another example, the feature generation rules 206 can analyze a raw data record to determine if a receipt is missing from an expense entry and output a feature (e.g., a Boolean or integer value) indicating as such. As another example, the feature generation rules 206 can utilize a list of high-risk entities and output a feature (e.g., a Boolean or integer value), indicating whether the raw data record includes an identifier of an entity in the list of high-risk entities. As another example, the feature generation rules 206 can analyze the raw data records to determine if the raw data record reflects a cash withdrawal expense and output a feature (e.g., a Boolean or integer value) indicating as such. The foregoing examples are not intended to be limiting, and similar types of features can be generated.

In further embodiments, the feature generation rules 206 can also apply aggregate operations on not only a single raw data record but an entire corpus of data records. In these embodiments, the feature generation rules 206 can access a corpus of raw data records as well as the raw data record being processed by feature generator 202. The feature generation rules 206 can then generate aggregate measurements for the raw data record being processed by feature generator 202. As one example, a raw data record being processed by feature generator 202 may include a user identifier. The feature generation rules 206 can query the raw data store 104 to load a corpus of raw data records for the user identifier. In some embodiments, this query can be time-limited to a specific range of raw data records (e.g., the last year of raw data records). The feature generation rules 206 can then generate an aggregate value based on the corpus of raw data records. For example, the feature generation rules 206 can compute a total amount in the corpus, an average expense amount in the corpus, a distribution frequency of raw data records, etc. Similar operations can be performed on other fields (e.g., aggregation features for merchants, dates, etc.).

In some embodiments, the feature generator 202 can also provide raw data records to feature ML models 204. In some embodiments, the feature generator 202 can provide the raw data record to feature ML models 204 in parallel with the processing of feature generation rules 206. In some embodiments, the feature ML models 204 can comprise an ML model configured to generate a feature based on the raw data record. In some embodiments, the ML model can comprise a supervised or unsupervised ML model. In some embodiments, the feature ML models 204 are extensible and can be updated, added to, removed from, as needed, and thus the specific ML models used are not intended to be limiting. As one example, the feature ML models 204 can include a multiclass classification model (e.g., a neural network, decision tree, random forest, gradient-boosted decision tree, etc.) that can predict the classification of raw data records. In some embodiments, the feature ML models 204 can comprise a multinomial logistic regression model. In some embodiments, such a model can be trained with a corpus of historically accurately classified raw data records (e.g., verified by, for example, audit platform 110). In some embodiments, the output (e.g., predicted classification) of such a model is compared to the actual classification of the raw data record, and a corresponding feature (e.g., Boolean or integer value) can be output as a new feature representing a misclassification. As another example, a support vector machine (SVM) model or Density-Based Spatial Clustering of Applications with Noise (DBSCAN) model can be used to generate an anomaly prediction based solely on the raw data record. As with the previous example, such a model can be trained (unless unsupervised, like DBSCAN) using the verified auditing results (e.g., from audit platform 110). As discussed previously, purely ML anomaly detection models fail to consider a raw data record’s overall risk to an organization; however, such models may be useful as input feature generation for the hybrid model described below.

In an embodiment, the feature generation rules 206 and the feature ML models 204 can return any generated features to feature generator 202. In response, the feature generator 202 can include the generated features in the feature set transmitted to ML models 208, rule-based filters (e.g., rule-based filter 210A, rule-based filter 210B, and rule-based filter 210N), and isolated rule-based filter 212.

In an embodiment, the ML models 208, rule-based filters (e.g., rule-based filter 210A, rule-based filter 210B, and rule-based filter 210N), and isolated rule-based filter 212 can each receive the feature set generated by feature generator 202. In other embodiments, the ML models 208, rule-based filters (e.g., rule-based filter 210A, rule-based filter 210B, and rule-based filter 210N), and isolated rule-based filter 212 can receive a subset of all the features generated by feature generator 202. Specifically, each of the ML models 208, rule-based filters (e.g., rule-based filter 210A, rule-based filter 210B, and rule-based filter 210N), and isolated rule-based filter 212 can receive only those features necessary to generate an interim score (described below).

In an embodiment, the ML models 208 are configured to receive a feature set and generate a score. In general, the ML models 208 comprise ensemble ML models configured to identify anomalous data records based on unknown risk factors or evolving practices in capturing the raw data records. In some embodiments, the ML models 208 can comprise an ensemble of unsupervised ML models. In some embodiments, the output of the ML models 208 can comprise a measure of deviation from a “normal” data record (e.g., a data record having the most common or average features).

In an embodiment, the ML models 208 can include an autoencoder network. In an embodiment, the autoencoder network includes two components: an encoder network and a decoder network. In an embodiment, the encoder network comprises a set of hidden layers (and activation layer) that converts the feature set (i.e., vector) into a hidden representation vector, while the decoder network comprises a second set of hidden layers (and second activation layer) that converts the hidden representation into an approximation of the original feature set. In some embodiments, the autoencoder network can comprise a deep autoencoder network that includes multiple fully connected hidden layers. In some embodiments, the feature set received by ML models 208 can be converted into a purely numerical feature set via, as one example, one-hot encoding or similar techniques. In some embodiments, the autoencoder network can be trained on a rolling basis using feature sets generated from the raw data records in an unsupervised manner. In some embodiments, a given output of the autoencoder can be considered to indicate that the feature set is anomalous if the reconstruction error of the autoencoder is above a pre-configured threshold.

In another embodiment, the ML models 208 can include an isolation forest model. In an embodiment, the isolation forest model can predict the distance between a given feature set and other feature sets. In an embodiment, during prediction, the isolation forest model can recursively generate partitions on the feature set by randomly selecting a feature and then randomly selecting a split value for the feature, between the minimum and maximum values allowed for a given feature. In an embodiment, feature sets generated from existing raw data records can be used to build isolation trees using this recursive partitioning process. Then, during prediction, each feature set can be passed through the isolation trees built during training to generate a corresponding score.

In another embodiment, the ML models 208 can include a histogram-based outlier score (HBOS) model. When using an HBOS model, the ML models 208 can generate a histogram of potential values for each feature of a corpus of feature sets. In essence, an HBOS model computes the density or popularity of potential values for each feature in a feature set. As with isolation forests and autoencoders, a corpus of feature sets can be used to build the per-feature histograms. During prediction, a given feature set’s features can be compared to the feature densities and given a score based on how closely each feature in the feature set it to the most popular corresponding value. In some embodiments, individual distances of features in a feature set can be summed to generate a score for the entire feature set.

In yet another embodiment, the ML models 208 can include multiple models. For example, the ML models 208 can include each of an autoencoder model, an isolation forest model, and an HBOS model. In such an embodiment, the outputs of each model can be aggregated to form a score. In some embodiments, the outputs of each model can further be weighted and/or normalized to a common scale before aggregating. In some embodiments, a linear regression model can be used to weight the outputs of each model.

In an embodiment, the risk scorer 106 also includes rule-based filters (e.g., rule-based filter 210A, rule-based filter 210B, and rule-based filter 210N). As with ML models 208, the rule-based filters receive a feature set (or a subset thereof) and output scores. In an embodiment, each rule-based filter can comprise an operation performed on a feature. For example, each rule-based filter can analyze a feature and transform its value to a score. In some embodiments, the operation can comprise a linear operation; however, the disclosure is not limited as such. As one example, a rule-based filter can output a weight value based on the value of a feature or can multiple a weight by a feature value (if the feature value is numeric). For example, a rule-based filter can output a constant value if a particular merchant is detected in an expense record or can multiply an amount value by a weighting constant. As illustrated, the rule-based filters can include an arbitrary number of filters (e.g., rule-based filter 210A, rule-based filter 210B, and rule-based filter 210N) that can be defined per operator of the system (e.g., per-user, per-role, per-company etc.). The use of an adjustable number of rule-based filters allows for per-operator customization of the total risk score (discussed below).

In an embodiment, the outputs of the rule-based filters (e.g., rule-based filter 210A, rule-based filter 210B, and rule-based filter 210N) are aggregated via interim aggregation node 214. In some embodiments, the interim aggregation node 214 can perform a summation of all scores output by rule-based filters (e.g., rule-based filter 210A, rule-based filter 210B, and rule-based filter 210N). In other embodiments, other types of aggregation operations can be performed. For example, the interim aggregation node 214 can weigh the score outputs of each of the rule-based filters (e.g., rule-based filter 210A, rule-based filter 210B, and rule-based filter 210N) and then perform a summation. In another embodiment, the interim aggregation node 214 can sum the score outputs of the rule-based filters (e.g., rule-based filter 210A, rule-based filter 210B, and rule-based filter 210N) and then apply a sigmoid operation to normalize the resulting score to a fixed interval.

In addition to rule-based filters (e.g., rule-based filter 210A, rule-based filter 210B, and rule-based filter 210N), the risk scorer 106 can include isolated rule-based filter 212. In some embodiments, the isolated rule-based filter 212 operates like rule-based filters (e.g., rule-based filter 210A, rule-based filter 210B, and rule-based filter 210N) (e.g., performing a linear operation on a feature set or feature value). However, as illustrated, the score output of the isolated rule-based filter 212 bypasses the interim aggregation node 214 and thus has a stronger impact on the total score calculated by the total aggregation node 216 (discussed next). In some embodiments, the isolated rule-based filter 212 can be defined by an operator and can include multiple rule-based filters. For example, an operator may use a rule-based filter that linearly transforms a total cost feature of the feature set given its importance to the operator in defining an anomaly. Since the score output of the isolated rule-based filter 212 is not merged with the score outputs of rule-based filters (e.g., rule-based filter 210A, rule-based filter 210B, and rule-based filter 210N) (e.g., in interim aggregation node 214), it exerts a stronger influence on the total score generated by total aggregation node 216.

In an embodiment, the total aggregation node 216 aggregates the score output computed by the ML models 208, the interim aggregate score generated interim aggregation node 214, and any score outputs generated by isolated rule-based filters (e.g., isolated rule-based filter 212). Like interim aggregation node 214, the total aggregation node 216 can perform a summation, weighted summation, or similar operation. In some embodiments, the total aggregation node 216 can also perform an optional sigmoid operation or similar normalizing operation. In an embodiment, the output of the total aggregation node 216 can comprise the risk score of the feature set, which is ultimately persisted to risk score store 108 (as discussed in FIG. 1).

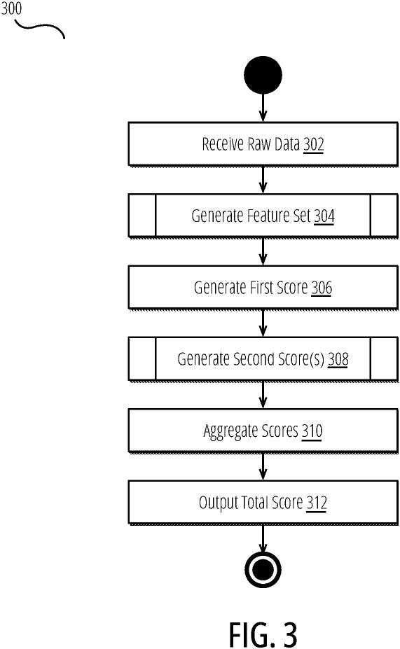

FIG. 3 is a flow diagram illustrating a method for assigning a risk score to a data record according to some of the example embodiments.

In step 302, method 300 can include receiving a raw data record. In some embodiments, the raw data record can be collected via an external collection system which can include any type of computing system or network that can collect data from users or other computing systems. As one example, the collection system can be an expense reporting system that allows users or computing devices to enter details of expense data records for an organization. Such expense data records can include, for example, line-item details, a report number, a category for the expense, an amount value, etc. In some embodiments, the collection system can periodically write data to a raw data store. In some embodiments, the raw data store can comprise any type of persistent data storage device. For example, the raw data store can comprise a relational database, NoSQL database, flat file, key-value database, big data storage device, etc. In some embodiments, the raw data store can comprise a canonical data source and thus may only be one-time writable by the collection system. In some embodiments, method 300 can read the raw data record from the raw data store and proceed to step 304. While a single raw data record is used as an example, method 300 can be re-executed (or modified) to read multiple raw data records from the raw data store.

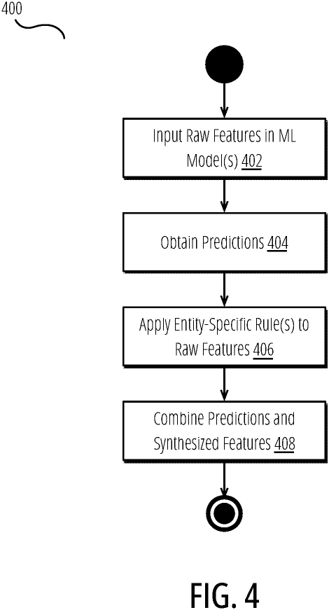

In step 304, method 300 can include generating a feature set for the raw data record. Further detail on step 304 is provided in the description of FIG. 4 and is not repeated herein. In general, step 304 can include converting a raw data record into a feature set that includes a plurality of individual features. In some embodiments, the features can include a mix of categorical and numerical features. In other embodiments, the features may include only categorical features. As discussed more fully in the description of FIG. 4, method 300 can output the feature set to ML models, rule-based filters, and isolated rule-based filters for further processing.

In an embodiment, the ML models, rule-based filters, and isolated rule-based filters can each receive the feature set generated in step 304. In other embodiments, ML models, rule-based filters, and isolated rule-based filters can receive a subset of all the features generated in step 304. Specifically, each of the ML models, rule-based filters, and isolated rule-based filters can receive only those features necessary to generate an interim score.

In step 306, method 300 can include generating a first score. In an embodiment, method 300 generates the first score using an ML model, the first score representing an anomaly score. In some embodiments, method 300 generates the first score by inputting the feature set into an ensemble ML model.

In an embodiment, the ML model can be configured to receive a feature set and generate a score. In general, the ML model can include an ensemble ML model configured to identify anomalous data records based on unknown risk factors or evolving practices in capturing the raw data records. In some embodiments, the ML model can comprise an ensemble of unsupervised ML models. In some embodiments, the output of the ML model can comprise a measure of deviation from a “normal” data record (e.g., a data record having the most common or average features).

In an embodiment, the ML model can include an autoencoder network, isolation forest model, or HBOS model. Details of these various types of models were provided previously in the description of FIG. 2 and are not repeated herein. In yet another embodiment, the ML model can include multiple models. For example, the ML model can include each of an autoencoder model, an isolation forest model, and an HBOS model. In such an embodiment, the outputs of each model can be aggregated to form an interim score. In some embodiments, the outputs of each model can further be weighted and/or normalized to a common scale before aggregating. In some embodiments, a linear regression model can be used to weight the outputs of each model.

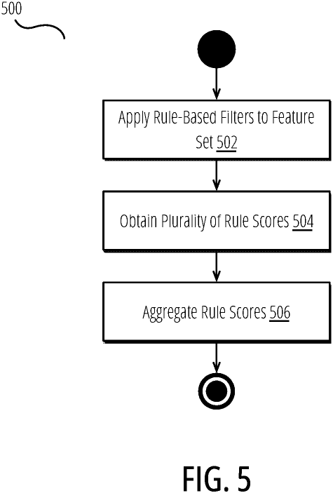

In step 308, method 300 can include generating one or more second scores based on the feature set. Further detail of step 308 is provided in the description of FIG. 5 and not repeated herein. In general, step 308 can include generating a plurality of scores using operations executed on the features in the feature set. In an embodiment, the operations can include weighting or other linear operations applied directly to the features based on entity-defined rules. In some embodiments, the outputs of rule-based filters can be aggregated to form an interim score. In some embodiments, certain filters can be used in isolation without being aggregated.

In step 310, method 300 can include aggregating the first score and one or more second scores to obtain a total score.

In an embodiment, step 310 can include aggregating the score output computed by the ML model (step 306), an interim aggregate score generated based on the score outputs of any rule-based filters (step 308), and any score outputs generated by isolated rule-based filters (step 308). In step 310, method 300 can perform a summation, weighted summation, or similar operation. In some embodiments, method 300 can also perform an optional sigmoid operation or similar normalizing operation as part of step 310. In an embodiment, the output of step 310 can comprise the risk score of a feature set, which is ultimately persisted to the risk score store.

In step 312, method 300 can include outputting the total score.

In an embodiment, method 300 can ultimately output the generated risk scores to a risk score store. In an embodiment, the risk score store can comprise any type of persistent data storage device. For example, the risk score store can comprise a relational database, NoSQL database, flat file, key-value database, big data storage device, etc. In some embodiments, method 300 can output only the risk scores and a reference (e.g., foreign key) to the corresponding raw data record stored in the raw data store to the risk score store. In other embodiments, method 300 can write the feature set used to generate a risk score along with the risk score to the risk score store. In some embodiments, method 300 can write the raw data, the feature set, and the risk score to the risk score store.

FIG. 4 is a flow diagram illustrating a method for generating a feature set based on a raw data record according to some of the example embodiments.

In step 402, method 400 can include inputting raw features into one or more ML models. In step 404, method 400 can include obtaining predictions from the ML models.

In some embodiments, method 400 can provide raw data records to feature ML models. In some embodiments, method 400 can provide the raw data record to feature ML models in parallel with the processing of feature generation rules (discussed in step 406). In some embodiments, the feature ML models can include an ML model configured to generate a feature based on the raw data record. In some embodiments, the ML model can comprise a supervised or unsupervised ML model. In some embodiments, the feature ML models are extensible and can be updated, added to, removed from, as needed, and thus the specific ML models used are not intended to be limiting. As one example, the feature ML models can include a multiclass classification model (e.g., a neural network, decision tree, random forest, gradient-boosted decision tree, etc.) that can predict the classification of raw data records. In some embodiments, the feature ML models can comprise a multinomial logistic regression model. In some embodiments, such a model can be trained with a corpus of historically accurately classified raw data records. In some embodiments, the output (e.g., predicted classification) of such a model is compared to the actual classification of the raw data record, and a corresponding feature (e.g., Boolean or integer value) can be output as a new feature representing a misclassification. As another example, an SVM model, principal component analysis (PCA) model, or DBSCAN model can be used to generate an anomaly prediction based solely on the raw data record. As with the previous example, such a model can be trained (unless unsupervised, like DBSCAN or PCA) using the verified auditing results (e.g., from an audit platform). As discussed previously, purely ML anomaly detection models fail to consider a raw data record’s overall risk to an organization; however, such models may be useful as input feature generation for the hybrid model described below.

In step 406, method 400 can include applying entity-specific rules to the engineered features and/or the raw features. In some embodiments, the entity-specific rules can include one or more rule-based filters and zero or more isolated rule-based filters.

In an embodiment, method 400 can apply procedural operations to features to obtain synthesized features. In an embodiment, these procedural operations may be stateless. That is, the rules can be applied in a repeatable manner to a given set of features. In some embodiments, the procedural operations are applied only to the engineered features (e.g., the predictions of step 404). However, in other embodiments, the procedural operations can be applied to raw features. In some embodiments, the procedural operations can be applied to both raw features and engineered features.

As one example, method 400 can analyze a date feature and output a Boolean feature that indicates the day of the week. As another example, method 400 can analyze a data record to determine if a receipt is missing from an expense entry and output a feature (e.g., a Boolean or integer value) indicating as such. As another example, method 400 can utilize a list of high-risk entities and output a feature (e.g., a Boolean or integer value), indicating whether the data record includes an identifier of an entity in the list of high-risk entities. As another example, method 400 can analyze the data records to determine if the data record reflects a cash withdrawal expense and output a feature (e.g., a Boolean or integer value) indicating as such. The foregoing examples are not intended to be limiting, and similar types of features can be generated.

In further embodiments, method 400 can also apply aggregate operations on not only a single data record but an entire corpus of data records. In these embodiments, method 400 can access a corpus of data records as well as the raw data record being processed. Method 400 can then generate aggregate measurements for the data record being processed. As one example, a data record being processed by method 400 may include a user identifier. Method 400 can query the data store to load a corpus of raw data records for the user identifier. In some embodiments, this query can be time-limited to a specific range of data records (e.g., the last year of data records). Method 400 can then generate an aggregate value based on the corpus of data records. For example, method 400 can compute a total amount in the corpus, an average expense amount in the corpus, a distribution frequency of data records, etc. Similar operations can be performed on other fields (e.g., aggregation features for merchants, dates, etc.).

In step 408, method 400 can include combining the predictions and features synthesized in step 406.

In some embodiments, step 408 can also include using raw features from the data record as features. In an embodiment, raw features comprise data in raw data records that is included, unchanged, in the feature set. For example, a dollar amount of an expense or a date may be included as a raw feature. In some embodiments, method 400 can be configured to select a subset of the raw features for inclusion in the feature set (or for further processing, discussed next). For example, an operator of the system can select a small subset of raw features to seed the method.

In an embodiment, the feature generation rules and the feature ML models can return generated features. In response, method 400 can include the generated features (as well as raw features, if implemented) in the feature set transmitted to ML models, rule-based filters, and isolated rule-based filters (as described starting in step 306 of FIG. 3).

FIG. 5 is a flow diagram illustrating a method for applying one or more rule-based filters to a feature set according to some of the example embodiments.

In step 502, method 500 can include applying one or more rule-based filters to the feature set. In step 504, method 500 can obtain the rule score outputs of the rule-based filters.

As with ML models (discussed in FIG. 4), rule-based filters receive a feature set (or a subset thereof) and output scores. In an embodiment, each rule-based filter can comprise an operation performed on a feature. For example, each rule-based filter can analyze a feature and transform its value to a score. In some embodiments, the operation can comprise a linear operation; however, the disclosure is not limited as such. As one example, a rule-based filter can output a weight value based on the value of a feature or can multiply a weight by a feature value (if the feature value is numeric). For example, a rule-based filter can output a constant value if a particular merchant is detected in an expense record or can multiply an amount value by a weighting constant. As illustrated, the rule-based filters can include an arbitrary number of rule-based filters that can be defined per operator. The use of an adjustable number of rule-based filters allows for per-operator customization of the total risk score.

In addition to rule-based filters, steps 502 and 504 can also include inputting the feature set into one or more isolated rule-based filters. In some embodiments, an isolated rule-based filter operates like a rule-based filter (e.g., performing a linear operation on a feature set or feature value). However, as discussed next, the output of an isolated rule-based filter is not aggregated with other rule-based filter outputs.

In step 506, method 500 can include aggregating the rule score outputs to generate an interim score output.

In an embodiment, method 500 can aggregate the outputs of the rule-based filters. In some embodiments, method 500 can perform a summation of all scores output by rule-based filters. In other embodiments, other types of aggregation operations can be performed. For example, method 500 can weigh the score outputs of each of the rule-based filters and then perform a summation. In another embodiment, method 500 can sum the score outputs of the rule-based filters and then apply a sigmoid operation to normalize the resulting score to a fixed interval.

As part of step 506, method 500 can bypass aggregating the score output of any isolated rule-based filters. In some embodiments, the isolated rule-based filter can be defined by an operator and can include multiple rule-based filters. For example, an operator may use a rule-based filter that linearly transforms a total cost feature of the feature set given its importance to the operator in defining an anomaly Since the score output of the isolated rule-based filter is not merged with the score outputs of rule-based filters, it exerts a stronger influence on the total score generated in step 312 of FIG. 3.

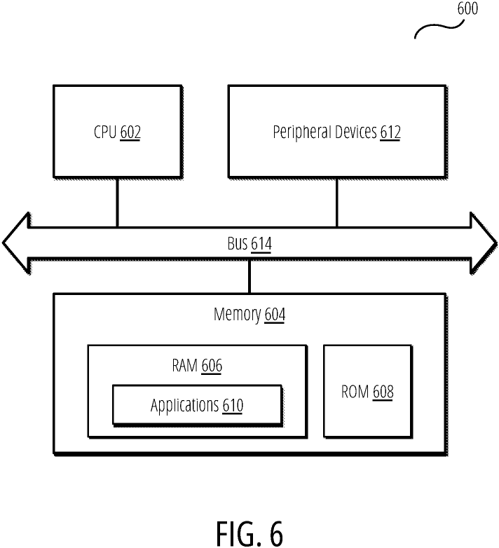

FIG. 6 is a block diagram of a computing device according to some embodiments of the disclosure.

In some embodiments, the computing device 600 can be used to perform the methods described above or implement the components depicted in the foregoing figures.

As illustrated, the computing device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a non-transitory memory system including a dynamic random-access memory (DRAM), static random-access memory (SRAM), Flash (e.g., NAND Flash), or combinations thereof. In one embodiment, bus 614 may comprise a Peripheral Component Interconnect Express (PCIe) bus. In some embodiments, bus 614 may comprise multiple busses instead of a single bus.

Memory 604 illustrates an example of non-transitory computer storage media for the storage of information such as computer-readable instructions, data structures, program modules, or other data. Memory 604 can store a basic input/output system (BIOS) in read-only memory (ROM), such as ROM 608, for controlling the low-level operation of the device. The memory can also store an operating system in random-access memory (RAM) for controlling the operation of the device

Applications 610 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The computing device 600 may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth™, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, the claimed or covered subject matter is intended to be broadly interpreted. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “or,” “and,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur in any order other than those noted in the illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a processor, raw data representing interactions;
generating, by the processor, a feature set based on the raw data, a given feature in the feature set including at least a portion of the raw data and at least one engineered feature;
generating, by the processor, a first score for the feature set using a machine learning (ML) model, the first score representing an anomaly score;
generating, by the processor, one or more second scores, each score in the one or more second scores generated by performing a linear operation on one or more features in the feature set;
aggregating, by the processor, the first score and the one or more second scores to generate a total score; and
outputting, by the processor, the total score.

2. The method of claim 1, wherein generating the first score for the feature set using the ML model comprises inputting the feature set into an ensemble ML model.

3. The method of claim 2, wherein the ensemble ML model comprises an autoencoder network.

4. The method of claim 2, wherein the ensemble ML model comprises an isolation forest.

5. The method of claim 2, wherein the ensemble ML model comprises a histogram-based outlier score model.

6. The method of claim 1 further comprising generating the at least one engineered feature using a second ML model configured to predict a misclassification of the raw data.

7. The method of claim 1 further comprising generating a third score, the third score generated based on comparing a numerical feature in the raw data to a fixed scale of numerical values.

8. A non-transitory computer-readable storage medium for tangibly storing computer program instructions capable of being executed by a processor, the computer program instructions defining steps of:
receiving, by the processor, raw data representing interactions;
generating, by the processor, a feature set based on the raw data, a given feature in the feature set including at least a portion of the raw data and at least one engineered feature;
generating, by the processor, a first score for the feature set using a machine learning (ML) model, the first score representing an anomaly score;
generating, by the processor, one or more second scores, each score in the one or more second scores generated by performing a linear operation on one or more features in the feature set;
aggregating, by the processor, the first score and the one or more second scores to generate a total score; and
outputting, by the processor, the total score.

9. The non-transitory computer-readable storage medium of claim 8, wherein generating the first score for the feature set using the ML model comprises inputting the feature set into an ensemble ML model.

10. The non-transitory computer-readable storage medium of claim 9, wherein the ensemble ML model comprises an autoencoder network.

11. The non-transitory computer-readable storage medium of claim 9, wherein the ensemble ML model comprises an isolation forest.

12. The non-transitory computer-readable storage medium of claim 9, wherein the ensemble ML model comprises a histogram-based outlier score model.

13. The non-transitory computer-readable storage medium of claim 8, wherein the steps further comprise generating the at least one engineered feature using a second ML model configured to predict a misclassification of the raw data.

14. The non-transitory computer-readable storage medium of claim 8, wherein the instructions further configure the computer to generate a third score, the third score generated based on comparing a numerical feature in the raw data to a fixed scale of numerical values.

15. A system comprising:
a processor configured to:
receive, by the processor, raw data representing interactions;
generate, by the processor, a feature set based on the raw data, a given feature in the feature set including at least a portion of the raw data and at least one engineered feature;
generate, by the processor, a first score for the feature set using a machine learning (ML) model, the first score representing an anomaly score;
generate, by the processor, one or more second scores, each score in the one or more second scores generated by performing a linear operation on one or more features in the feature set;
aggregate, by the processor, the first score and the one or more second scores to generate a total score; and
output, by the processor, the total score.

16. The system of claim 15, wherein generating the first score for the feature set using the ML model comprises inputting the feature set into an ensemble ML model.

17. The system of claim 16, wherein the ensemble ML model comprises an autoencoder network.

18. The system of claim 16, wherein the ensemble ML model comprises an isolation forest.

19. The system of claim 16, wherein the ensemble ML model comprises a histogram-based outlier score model.

20. The system of claim 15, wherein the processor is further configured to generate the at least one engineered feature using a second ML model configured to predict a misclassification of the raw data.
